(19) United States
(12) Patent Application Publication
(10) Pub. No.: US 2012/0137280 A1
(43) Pub. Date: May 31, 2012

(54) ELECTRONIC FIGURE AND ELECTRONIC FIGURE SYSTEM

(75) Inventors: Sheng-Chun Lin, Taipei City (TW); Yu-Chuan Chang, Kaohsiung City (TW); Yu-Shiang Hung, Taipei City (TW)

(73) Assignee: INSTITUTE FOR INFORMATION INDUSTRY

(21) Appl. No.: 13/171,571

(22) Filed: Jun. 29, 2011

(30) Foreign Application Priority Data
Nov. 26, 2010 (TW) 99140946

(51) Int. Cl. G06F 15/16; G06F 17/30; G06F 9/44

(52) U.S. Cl. 717/171; 709/223; 707/812; 707/E17.005

(57) ABSTRACT

An embodiment of the invention provides an electronic figure. The electronic figure comprises a storage device, a function library and a processing unit. The storage device stores identification data corresponding to an account of a network service system. The function library stores a plurality of function programs and each function program corresponds to a first parameter which is used to determine whether the corresponding function program can be executed. The processing unit executes the function programs according to the corresponding first parameters.

### CROSS REFERENCE TO RELATED APPLICATIONS

This application claims priority of Taiwan Patent Application No. 099140946, filed on Nov. 26, 2010, the entirety of which is incorporated by reference herein.

### BACKGROUND OF THE INVENTION

1. Field of the Invention

The present invention relates to an electronic figure, and in particular relates to an electronic figure and electronic figure system incorporated with a social network or an online game.

2. Description of the Related Art

Electronic figures or dolls are popular items. In addition to static electronic figures, electronic figures have been developed. Electronic figures can be manipulated by electronic signals to increase applications thereof.

As an example, an electronic figure device or an electronic figure, supporting multiple instant communication software/real-time communication software, can connect to a personal computer, such that notifications can be performed when messages or new email messages are received, and when the statuses of friends become on-line statuses in the instant communication software/real-time communication software. In another example, functions in demand for an electronic figure (such as an electronic rabbit figure) can be set via a computer, and a server can transmit related data, such as weather forecasts, or headline news to the electronic figure, so that data is displayed via the electronic figure.

Generally, conventional electronic figures can only receive predefined messages, and perform related operations according to the received messages. Some electronic figures can perform related operations, such as music playback and dancing based on predefined programs. However, since these programs are predefined and burned into the electronic figures, flexibility of operating the electronic figures is limited, thus hindering popularity among users and development of the electronic figures. Accordingly, with limited variability, users often quickly lose interest in the electronic figures.

### BRIEF SUMMARY OF THE INVENTION

An embodiment of the invention provides an electronic figure. The electronic figure comprises a storage device, a function library stored in a database or a storage medium and a processing unit. The storage device stores identification data corresponding to an account of a network service system. The function library stores a plurality of function programs and each function program corresponds to a first parameter which is used to determine whether the corresponding function program can be executed. The processing unit executes the function programs according to the corresponding first parameters.

An embodiment of the invention provides an electronic figure system comprising an electronic figure and a functional base device. The electronic figure comprises a communication unit, a storage unit and a processing unit, wherein the communication unit communicates with the functional base device, and the storage unit stores identification data corresponding to an account of a network service system. The functional base device comprises a base communication unit, a function library stored in a database or a storage medium and a base processing unit, wherein the base communication unit communicates with the electronic figure. The function library comprises a plurality of function programs, and each function program corresponds to a first parameter that is determined according to the account to determine whether the corresponding function program can be executed. The base processing unit processes the function program according to the first parameter to generate instructions, and the processing unit of the electronic figure executes the instructions.

An embodiment of the invention provides a network service system for an electronic figure. The network service system communicates with the electronic figure via a communication network. The electronic figure comprises identification data corresponding to an account of the network service system and a plurality of function programs, wherein each function program corresponds to a first parameter to determine whether the corresponding function program can be executed. The network service system comprises a storage device, a communication device, a service module and an application module. The storage device stores the account and a level-function correspondence chart. The communication device communicates with the electronic figure via the communication network. The service module provides a network service. The application module determines and transmits the first parameter to the electronic figure according to the account corresponding to the identification data and the level-function correspondence chart.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a functional block diagram of an embodiment of an electronic figure according to the invention.

FIG. 2 is a functional block diagram of an embodiment of an electronic figure system according to the invention.

FIG. 3 is a schematic diagram of a network service system of an electronic figure according to an embodiment of the invention.

FIG. 4 is a level-function correspondence chart according to an embodiment of the invention.

FIG. 5 is a schematic diagram of an electronic figure system according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

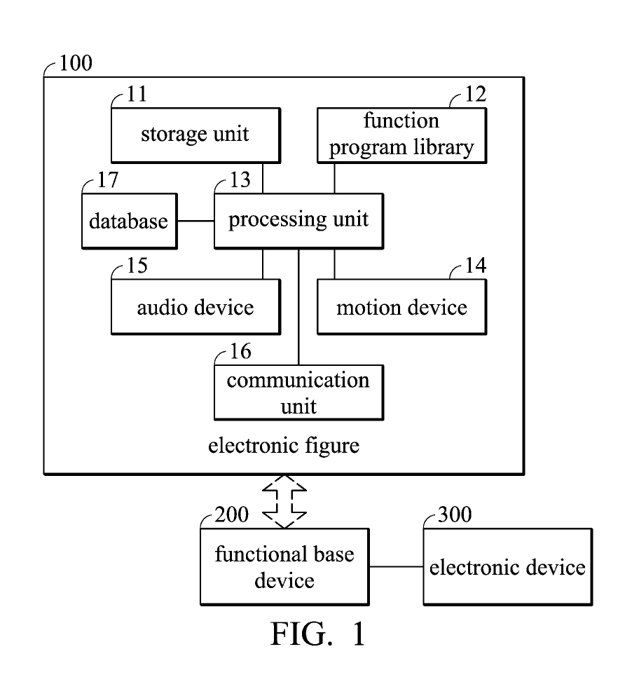

FIG. 1 is a functional block diagram of an embodiment of an electronic figure according to the invention. The electronic figure 100 connects to the electronic device 300 via the functional base device 200, and the electronic device 300 accesses a network service system via a communication network. In this embodiment, the electronic figure 100 can be an access medium for a network service. When the electronic figure is placed on or close to the functional base device 200, a user can access and log into the network service system via the functional base device 200. In the present disclosure, the network service system is an online game, a social network, an internet forum or other similar network service.

The electronic figure 100 comprises a storage unit 11, a function program library 12 and a processing unit 13. The storage unit 11 stores identification data corresponding to an account of a network service. For example, when a user first logs into the network service via an account server, an account-identification data correspondence chart or relation data for the identification data and user account can be established in the account server. After that, when user uses the electronic figure to access or use the network service, the electronic figure transmits the identification data to the account server and then automatically logs into the network service for the user.

The embodiments of the connection between the electronic figure 100 and the network service are described in the following. The electronic figure 100 first connects to the functional base device 200 via the communication unit 106, such as a sensing device. The functional base device 200 comprises a receiving unit to receive signals from the electronic figure 100 and a base communication unit to connect to an electronic device 300, such as computer or wireless communication device. The electronic device 300 connects to the account server via the communication network. In another embodiment, the electronic figure 100 can use a network communication device to directly connect to the account server via the communication network. The communication unit 16 can connect to the functional base device 200 via a wireless internet interface, a Bluetooth interface, an Infrared Data Association (IrDA) interface, a wireless radio frequency interface, a USB (Universal Serial Bus) wired/wireless communication recognition system, a 2-dimension/3-dimension barcode recognition system or other contactless connection mechanism. In addition to the contactless connection mechanism/non-contact connection system, the electronic figure 100 can connect to the functional base device 200 via a connection cable, such as a RS-232 cable.

The function library 12 of the electronic figure 100 stores a plurality of function programs for specific actions or a show performed by the electronic figure 100. In this embodiment, the function library 12 is stored in a database or a storage medium, such as a flash memory or a hard drive. Each function program corresponds to one of first parameters, and the first parameters are used to determine which function program can be executed by the processing unit 13. In other words, the function programs in the function library 12 is not entirely executed by the processing unit 13 in the beginning, and which function program can be executed by the processing unit 13 is determined according to the first parameters. An embodiment of the first parameters are data comprising a plurality of bits, wherein each bit corresponds to one function program and the value of each bit, 0 or 1, is used to determine whether the corresponding function program can be executed by the processing unit 13. For example, when a value of a first parameter corresponding to a first function program is 0, the first function program cannot be executed by the processing unit 13. When a value of a first parameter corresponding to a second function program is 1, the second function program can be executed by the processing unit 13.

In another embodiment, the first parameter of each function program is determined by a second parameter corresponding to the account of the network service system. For example in an online game, the account server comprises a level-function correspondence chart which records level data of a plurality of user accounts in the online game, wherein each level data corresponds to one of a plurality of user accounts and can be regarded as a second parameter. The first parameters corresponding to the function programs of the electronic figure 100 can be determined/change according to the level data. Thus, which function program of the function library 12 to be executed by the processing unit 13 of the electronic figure can be determined according to the second parameter, such as the level data of the user account in the online game. The higher the level data of a user account is, the more function programs of the library 12 the processing unit 13 can be executed for the user. Furthermore, a new function program can be downloaded and added to the function library 12 via the functional base device 200 and the electronic device 300 according to the user information.

The processing unit 13 executes the executable function programs according to the first parameters. In some embodiment, the electronic figure 100 comprises an audio device 15 and a motion device 13 that are controlled by the processing unit 13. A control program for electronic figure can be initially embedded in the processing unit 13, or can be first stored in the storage unit 11 and then be acquired and executed by the processing unit 13. When the function programs stored in the function library 12 are executed by the processing unit 13, corresponding action is performed by the audio device 15 and the motion device 14. For example, the first parameter of an alert function stored in the function library 12 is set for determining that the alert function can be executed when the level of a user account is equal to or higher than a predetermined level. When a user's character corresponding to the user account is attacked in a game, the processing unit 13 informs or alerts the user by controlling the audio device 15 to play a specific sound effect or music. The processing unit 13 can also use the motion device 14 to inform or alert the user. In this embodiment, the motion device 14 is a vibration device to vibrate the electronic figure. When the alert function is executed and the user's character is attacked in the game, the processing unit 13 vibrates the electronic figure 100 by the motion device 13 to inform the user of the attack.

In another embodiment, the electronic figure 100 further comprises a database 17 to store an interactive data of the account for user in the network service system. For example, if the network service system is a social network service, the database 17 can store a user's conversation log, which may include a text dialog, emotion icons, sharing of pictures or internet links.

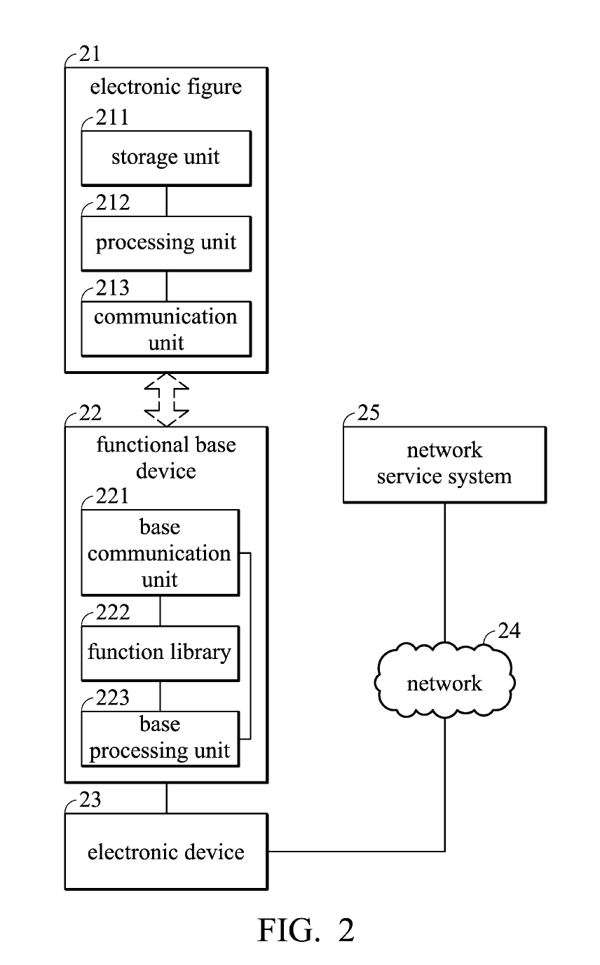

Electronic FIG. 2 is a block diagram of an embodiment of an electronic figure system according to the invention. The electronic figure system can be incorporated with an online game, a social network, and instant communication software, an instant messenger or other similar network services to improve the interaction between the network service and a user. The electronic figure system comprises an electronic figure 21 and functional base device 22. The electronic figure 22 comprises a communication unit 213, a storage unit 211 and a processing unit 212. The communication unit 213 communicates with the functional base device 22. The storage unit 211 stores identification data corresponding to an account of a network service system 25. An embodiment of the storage unit 212 is a sensing chip. The functional base device 22 comprises a base communication unit 221, a function library 222 (which can stored in a database or a storage medium) and a base processing unit 223. The base communication unit 221 communicates with the communication unit 213 of the electronic figure 21 to access the identification data of the storage unit 211. In some embodiments, the base communication unit 221 accesses the storage unit 211 by a wireless radio frequency technology, an Infrared Data Association (IrDA) technology, a 2-dimension/3-dimension barcode recognition technology or other related technologies. In this embodiment, each function program corresponds to one first parameter, which is determined according to the account and is for determining if the function program can be executed. The base processing unit 223 executes the executable function program to generate corresponding instructions. The instructions are transmitted to the electronic figure 21 and executed by the processing unit 212.

The electronic device 23 connects to the functional base device 22 via the communication unit 213 and the communication interface may be a RS232 interface, an Infrared Data Association (IrDA) interface or Bluetooth interface. When the electronic figure 21 is placed on or close to the functional base device 22, the functional base device 22 senses and transmits the identification data of the electronic figure 21 to the network service system 25 via network 24. The network service system 25 comprises a second parameter corresponding to the account and the first parameter is determined according to the second parameter. The network service system 25 may comprise a level-function correspondence chart for recording various second parameters and the corresponding executable function programs which are executable for each second parameter. For example, the level of a user account is the second parameter and the network service system 25 determines which function program is executable according to the second parameter (such as level of user account) and the level-function correspondence chart. Then, the first parameter of the function program of the electronic figure 21 is modified or updated according to the executable function programs that are determined according to the second parameter and the level-function correspondence chart. Moreover, the base processing unit 223 downloads and adds an updated function program or a new function program from the network service system 25 to the function library 222 via the base communication unit 221.

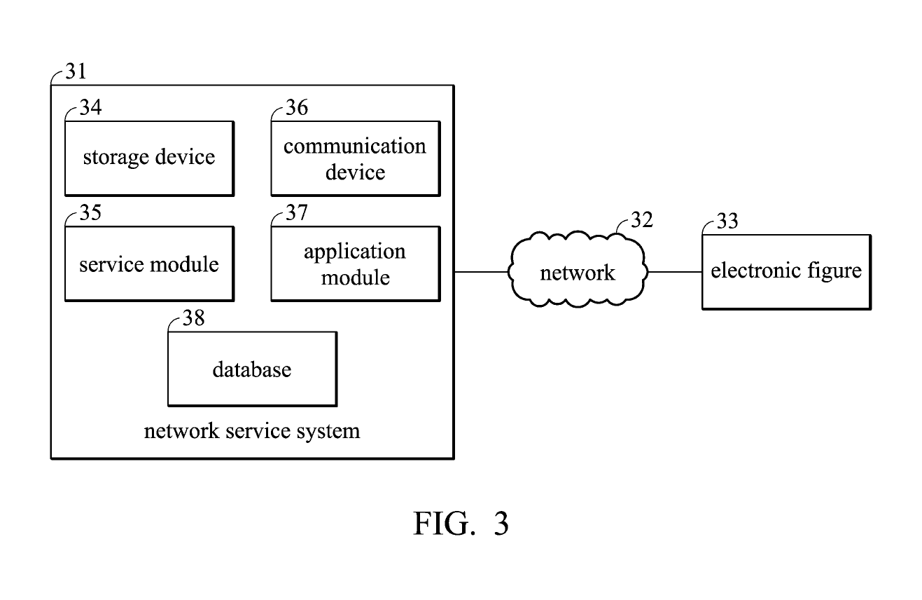

FIG. 3 is a schematic diagram of a network service system of an electronic figure according to an embodiment of the invention. The network service system 31 communicates with an electronic figure 33 via a network 32, wherein the electronic figure 33 comprises identification data corresponding to an account of the network service system and a plurality of function programs. Each function program corresponds to a first parameter and the first parameter determines whether the corresponding function program can be executed. The network service system 31 comprises a storage device 34, a communication device 36, a service module 35, an application module 37 and a database 38. It is noted that the described elements may be embedded in different electronic devices and the described elements are linked by the wired/wireless interface or a RS-232 cable even though the network service system 31 of the embodiment is illustrated by an apparatus including all the described elements. The storage device 34 stores the account corresponding to the electronic figure 33 and a level-function correspondence chart. The communication device 36 communicates with the electronic figure 33 via the network 32. The service module 35 provides a network service, such as an online game, social network or internet forum. The application module 37 determines and transmits the first parameters to the electronic figure 33 according to the account corresponding to the identification data and the level-function correspondence chart. The database 38 stores an interactive data of the account for the network service.

The service module 35 further provides and transmits an updated function program to the electronic figure 33 according to the account. The electronic figure 33 further comprises a control program for electronic figure 33 and the application module 37 can download and transmit an update software from the service module 35 to the electronic figure 33 to update the control program for electronic figure 33. In another embodiment, the network service system communicates with the electronic figure 33 via the network 32 and a functional base device (not shown in FIG. 3), and the function programs can be stored in the functional base device. In another embodiment, the application module is embedded in an electronic device and the electronic device connects to the electronic figure 33 via the functional base device. The application 37 further comprises an application program. When user wants to use the network service provided by the service module 35, a user can provide instructions to the application module 37 via the electronic figure 33 and then access the network service provided by the service module 35 via the application program.

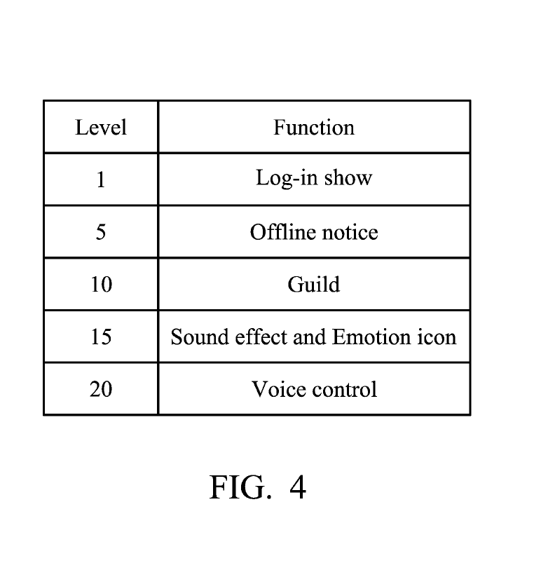

To further illustrate the level-function correspondence chart, please refer to FIG. 4. FIG. 4 is a level-function correspondence chart according to an embodiment of the invention. The level-function correspondence chart may be stored in the storage device 34 of FIG. 3 or other similar device. The application programs or instruction sets for the function programs are stored in the function library of the electronic figure 33 or the functional base device used by the electronic figure 33. When the level of user account (the second parameter) is 1, a log-in show function is activated and can be executed by the electronic figure control software of the electronic figure 33 through modifying the corresponding first parameter for determining that the log-in show function is executable. In some embodiments, the log-in show function plays scenario data, such as dialogues, sounds, images, sound effects, music, light signals, and/or actions of the electronic figures, such as swinging, vibrating, rotating, beating, movements and others.

In another embodiment, when the level of a user account reaches 5, an offline notice function is activated and can be executed by the electronic figure control software of the electronic figure 33 through modifying the corresponding first parameter for determining that the offline notice function is executable. When performing the offline notice function, the electronic figure can inform user the status of a user's character when the user does not use the network service provided by the service module 35. For example, the electronic figure 33 informs the user when the user's character has received a message from another user, or when the user's character is attacked or upgraded, the electronic figure 33 may play scenario data to inform user of the attack or upgrade.

If the level of a user account does not reach 5, only the log-in show function would be able to be executed by the control program for the electronic figure 33. When the level of a user account reaches 10, a guild function is activated and can be executed by the electronic figure control software of the electronic figure 33 through modifying the corresponding first parameter for determining that the guild function is executable. Users can join or create one guild when the guild function is activated. When the level of a user account reaches 15, a sound effect function and an emotion icon function may be activated. The electronic figure 33 plays a specific sound effect according to user interaction in the network service or the user dialog. The emotion icon function represents emotion icons according to a specific text which a user use in instant communication software. In another embodiment, the emotion icons can be performed by the electronic figure 33. The electronic figure 33 can present the emotion of happiness, being angry, or sadness or delight according to the text chat or the status of a user's character in the online game. When the level of a user account reaches 20, a voice control function is activated and can be executed by the electronic figure control software of the electronic figure 33. When the voice control function is executed, a user can control the electronic figure 33 by voice. For example, a user can control his character to attack or defend other character in a game when the voice control function is activated and the user is playing the online game. Although the level-function correspondence chart of FIG. 4 illustrates the operation of the function library of the invention, the invention is not limited thereto. Those skilled in the art can use other parameters of the network service and set other conditions to activate the function program. For example, if the network service is an internet forum, the number of posts of a user may be applied as a determination factor.

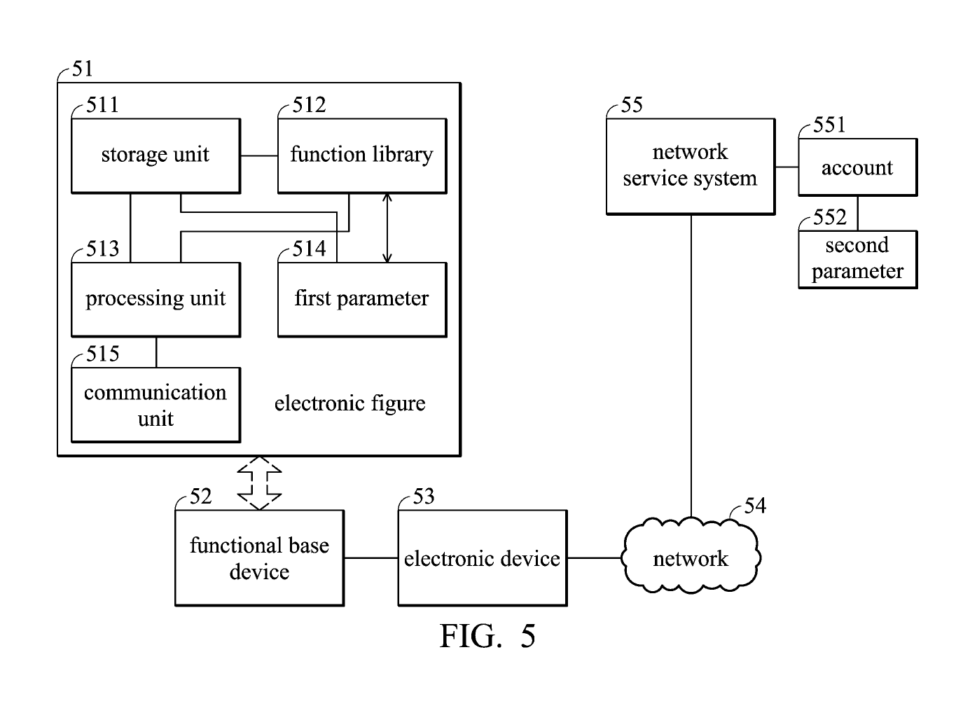

FIG. 5 is a schematic diagram of an electronic figure system according to an embodiment of the invention. The electronic figure 51 connects to an electronic device 53 via the functional base device 52, and the electronic device 53 connects to a network service system 55 via a network 54. The electronic figure 51 connects to the functional base device 52 via the communication unit 515 and the communication unit 515 connects to the functional base device 52 via a wireless network interface, a Bluetooth interface, an Infrared Data Association (IrDA) interface, a wireless radio frequency interface or other contactless connection mechanism. In addition to the contactless connection mechanism, the electronic figure 51 can connect to the functional base device 52 via a connection cable. The electronic figure 51 comprises a storage unit 511 to store identification data corresponding to an account 551 of a network service system 55. The function library 512 comprises a plurality of function programs, wherein each function program corresponds to one first parameter, and the first parameter determines, according to a second parameter 552 of the account 551, whether the processing unit 512 can execute the corresponding function program.

For example, assume the second parameter 552 is the level of the account 551. Thus, the first parameter 514 is updated via a determination mechanism according to the level, and the function programs that can be executed by the processing unit 513 are updated accordingly. In other embodiments, the second parameter 552 may be the number of posts, and the online time duration of other parameters that may vary according to the usage of a user in the network service provided by the network service system 55. An embodiment of the first parameter 514 may comprises a plurality of bits, wherein each bit corresponds to one function program and the value of each bit, 0 or 1, determines whether the corresponding function program can be executed by the processing unit 513. Furthermore, the function library 512 can download new function programs from the network system 55.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic figure, comprising:
a storage device to store identification data corresponding to an account of a network service system;
a function library storing a plurality of function programs, wherein each function program corresponds to a first parameter which is used to determine whether the corresponding function program can be executed; and
a processing unit to execute the function programs according to the corresponding first parameters.

2. The electronic figure as claimed in claim 1, wherein the electronic figure further comprises a communication unit and the electronic figure connects to a functional base device and an electronic device via the communication unit to communicate with the network service system.

3. The electronic figure as claimed in claim 2, wherein the first parameters are determined according to the account, and a second parameter corresponding to the account of the network service system is used to determine the first parameters corresponding to the function programs.

4. The electronic figure as claimed in claim 3, wherein the second parameter is determined according to the account and a level-function correspondence chart of the network service system.

5. The electronic figure as claimed in claim 2, wherein the processing unit downloads and adds an updated function program to the function library via the communication unit, the functional base device and the electronic device.

6. The electronic figure as claimed in claim 1, wherein the storage device further comprises a database to store an interactive data of the account in the network service system.

7. The electronic figure as claimed in claim 1, wherein the first parameter is encrypted by an encryption procedure and then stored in the electronic figure.

8. An electronic figure system, comprising an electronic figure and a functional base device, wherein:
the electronic figure comprises a communication unit, a storage unit and a processing unit, wherein the communication unit communicates with the functional base device, and the storage unit stores identification data corresponding to an account of a network service system; and
the functional base device comprises a base communication unit, a function library and a base processing unit, wherein the base communication unit communicates with the electronic figure, the function library comprises a plurality of function programs, each function program corresponds to a first parameter that is determined according to the account to determine whether the corresponding function program can be executed, and the base processing unit processes the function program according to the first parameter to generate instructions, and the processing unit of the electronic figure executes the instructions.

9. The electronic figure system as claimed in claim 8, wherein the first parameter is determined according to the account, and a second parameter corresponding to the account of the network service system is used to determine the first parameter corresponding to the function programs.

10. The electronic figure system as claimed in claim 9, wherein the second parameter is determined according to the account and a level-function correspondence chart of the network service system.

11. The electronic figure system as claimed in claim 9, wherein the base processing unit downloads and adds an updated function program from the network service system to the function library via the communication unit.

12. The electronic figure system as claimed in claim 9, wherein the storage unit further comprises a database to store an interactive data of the account in the network service system.

13. A network service system for an electronic figure, wherein the network service system communicates with the electronic figure via a communication network, the electronic figure comprises identification data corresponding to an account of the network service system and a plurality of function programs, and each function program corresponds to a first parameter to determine whether the corresponding function program can be executed, and the system comprises:
a storage device to store the account and a level-function correspondence chart;
a communication device to communicate with the electronic figure via the communication network;
a service module to provide a network service; and
an application module to determine and transmit the first parameter to the electronic figure according to the level-function correspondence chart and the account corresponding to the identification data.

14. The network service system as claimed in claim 13, wherein the application module provides an updated function program to the electronic figure according to the account.

15. The network service system as claimed in claim 13, wherein the electronic figure further comprises an electronic figure control software and the application module can provide an updated software to update the electronic figure control software.

16. The network service system as claimed in claim 13, further comprising:
a database storing an interactive data of the account in the network service system.
